(19) United States
(12) Patent Application Publication
(10) Pub. No.: US 2018/0154590 A1
(43) Pub. Date: Jun. 7, 2018

(54) METHOD OF CHECKING HEADPATH DATA

(71) Applicant: Composite Technology and Applications Limited, Derby (GB)

(72) Inventor: James Tingle, Derby (GB)

(21) Appl. No.: 15/815,424

(22) Filed: Nov. 16, 2017

(30) Foreign Application Priority Data
Dec. 7, 2016 (GB) 1620816.7

(51) Int. Cl. B29C 70/38; G05B 19/18

(52) U.S. Cl. CPC B29C 70/38; G05B 19/18

(57) ABSTRACT

There is disclosed a method of checking headpath data for a layup operation in which fibre reinforcement material is applied over a tool by an applicator roller of an applicator head biased against the tool along a compaction axis by a compaction force. The method comprises receiving baseline headpath data defining a baseline headpath position of the applicator head relative the tool; and determining a head displacement along the compaction axis corresponding to an equilibrium condition between the compaction force and a reaction force through the fibre reinforcement material. The method further comprises checking for at least one of a non-compacted portion of fibre reinforcement material and an intersection of the applicator head and an obstacle.

### PRIORITY

This application claims the benefit of priority under 35 U.S.C. § 119 to United Kingdom Patent Application No. 1620816.7, filed on Dec. 7, 2016, which is incorporated by reference herein in its entirety.

### SUMMARY

The present disclosure concerns a method of checking headpath data for a layup procedure.

It is known to conduct a layup procedure for the manufacture of a composite component by controlling an applicator head configured to apply fibre reinforcement material to move relative a tool to apply fibre reinforcement material onto the tool.

In a previously considered example of a layup procedure, a headpath for a layup procedure comprises a series of points on a surface a tool, and an applicator head is controlled to move relative the tool so that an applicator roller of the applicator head tracks the points defining the headpath.

According to a first aspect there is provided a computer-implemented method of checking headpath data for a layup operation in which fibre reinforcement material is applied over a tool by an applicator roller of an applicator head biased against the tool along a compaction axis by a compaction force, the method comprising: receiving baseline headpath data defining a baseline headpath position of the applicator head relative the tool for applying fibre reinforcement material onto a substrate surface by the applicator roller; determining a head displacement along the compaction axis corresponding to an equilibrium condition between the compaction force and a reaction force through the fibre reinforcement material applied by the applicator roller; and checking for at least one of: a non-compacted portion of fibre reinforcement material along a lateral extent of the applicator roller based on a deformation profile of the applicator roller at the equilibrium condition; and an intersection of the applicator head and an obstacle, based on the head displacement distance.

The baseline headpath position may be a position on a notional tool surface which defines a contact position of the applicator roller in an un-deformed configuration. In other words, the baseline headpath position may be a point for controlling the orientation (or position) of the applicator head so that the applicator roller would contact the notional tool surface at the baseline headpath position. For example, based on the baseline headpath position, the applicator head may be positioned so that the compaction axis intersects the baseline headpath position and so that the baseline headpath position is at a mid-point along a line of travel of the applicator roller (i.e. the range of movement of the applicator roller along the compaction axis), in particular the line of travel of a distal end of the applicator roller (the end farthest from a body of the applicator head) in an un-deformed configuration. The head displacement may correspond to (be equivalent to) the displacement of a roller axis of the applicator roller from a notional position of the roller in the un-deformed configuration in which it is in contact with the baseline headpath position, and an equilibrium position of the roller in a deformed configuration to press fibre reinforcement material against the substrate surface offset from the notional tool surface.

The applicator roller may be deformable (in other words, compressible or crushable) along its lateral extent. In its un-deformed configuration, the roller may be substantially cylindrical.

The method may further comprise simulating the substrate surface, for example, based on a headpath data defining how fibre-reinforcement is to be applied on the tool to progressively form the substrate.

The method may further comprise: determining an intersection of the applicator head in the baseline headpath position and an obstacle. An offset headpath position offset from the baseline headpath position may be defined to avoid the intersection. Production headpath data may be defined for a layup operation including the offset headpath position.

The intersection may be determined based on a geometry of the applicator head and a geometry of one or more obstacles, for example including the tool, a substrate applied on the tool (i.e. a pre-form, partially or fully applied), supports for the applicator head or the tool, and ancillary equipment such as vacuum bagging apparatus and heaters. The geometry of the applicator head may be relatively translatable and rotatable with respect to the geometry of the or each obstacle, for example, there may be six degrees of freedom for simulating their relative positions.

The method may comprise determining a non-compacted portion of fibre reinforcement material based on the deformation profile of the applicator roller at the equilibrium condition. An offset headpath position offset from the baseline headpath position may be defined based on the location of the non-compacted portion to laterally offset a centre of the applicator roller from a position on the substrate surface corresponding to the non-compacted portion. Production headpath data may be defined for a layup operation including the offset headpath position.

The lateral direction may be the binormal direction (or binormal vector) of a headpath over a substrate surface corresponding to the tool, the headpath having a headpath direction along which fibre reinforcement material is to be applied and passing through the baseline headpath position. For the avoidance of doubt, a binormal vector is a vector orthogonal to both a tangent vector of a curve and a normal vector of the curve.

The offset headpath position may be defined to inhibit non-compaction of fibre-reinforcement material along the lateral extent of the applicator roller. For example, non-compaction may occur owing to bridging of the applicator roller over a feature of a substrate surface—for example a local depression of the substrate surface. Defining the offset headpath position to be laterally offset from the baseline headpath position so that a centre of the applicator roller is laterally offset from the position on the substrate surface corresponding to non-compaction (e.g. the position of the respective feature) may cause either (i) the applicator roller to avoid (i.e. pass by) the respective position on the substrate surface to avoid non-compaction or (ii) the position on the substrate surface to move relatively towards an end region of the applicator roller. End regions of the applicator roller may be more flexible/deformable and/or less susceptible to bridging.

The centre of the applicator roller may be a lateral centre, such as a midpoint along the lateral extent of the applicator roller (e.g. on the roller axis or along the distal end of the applicator roller).

The method may further comprise repeating checking for a non-compacted portion of fibre reinforcement material and/or an intersection of the applicator head and an obstacle at the offset headpath position.

The offset headpath position may be iteratively defined. The offset headpath position may be defined by offsetting or deflecting a headpath for relative movement of the applicator head relative the tool.

The method may further comprise determining a non-compacted portion of fibre reinforcement material based on the deformation profile of the applicator roller at the equilibrium condition. Production headpath data may be defined for a layup operation including the baseline headpath position. The production headpath data may define a reduced lateral extent of fibre reinforcement to be applied at the baseline headpath position to exclude the non-compacted portion.

The production headpath data may be defined for a layup operation in which a plurality of laterally-adjacent tows are applied by the applicator roller. At least one tow may be determined to be non-compacted based on the deformation profile of the applicator roller at the equilibrium condition. The production headpath data may be defined to exclude at least one tow at the baseline headpath position.

A non-compacted portion may be determined when a corresponding portion of the deformation profile of the applicator roller is non-physical, or when a reaction force through the corresponding portion of the deformation profile is below a predetermined threshold.

The predetermined threshold may define a minimum force required for adequate compaction of fibre-reinforcement material. For example, the predetermined threshold may correspond to force per tow of 30N.

The deformation profile at the equilibrium condition may be determined by mapping the lateral profile of the applicator roller to the substrate surface. The equilibrium condition may be resolved to determine the head displacement by determining the reaction force through the fibre reinforcement material as a function of the deformation profile.

The reaction force through the fibre reinforcement material may be determined based on an iteratively-adjusted compaction profile defining regions of compaction of the fibre reinforcement material by the applicator roller along the lateral extent of the applicator roller. The compaction profile may be iteratively adjusted to exclude regions of non-physical deformation of the applicator roller to compact the fibre reinforcement material. Checking for a non-compacted portion of fibre reinforcement material may be based on the compaction profile. The reaction force through the fibre reinforcement material may be determined based on a correlation between deformation of the applicator roller and the reaction force which varies laterally along the applicator roller.

According to a second aspect there is provided a method of defining headpath data including a plurality of headpath positions defining a headpath of relative movement of an applicator head relative a tool to apply fibre reinforcement material onto a substrate surface by an applicator roller of the applicator head. According to the second aspect the headpath data for at least one of the headpath positions is checked and defined in accordance with the first aspect of the invention when a non-compaction of fibre reinforcement material is determined based on the deformation profile of the applicator roller at the equilibrium condition, and when production headpath data is defined for a layup operation including the baseline headpath position, wherein the production headpath data defines a reduced lateral extent of fibre reinforcement material to be applied at the baseline headpath position to exclude the non-compacted portion. According to the second aspect, a lateral extent of fibre-reinforcement material to be applied varies along the headpath.

It will be appreciated that a baseline headpath position may be defined as the result of previous iterations and adjustments (e.g. to offset a pre-existing headpath position).

According to a third aspect there is provided a non-transitory computer-readable storage medium comprising computer-readable instructions that, when executed by a processor, causes performance of a method in accordance with the first or second aspects.

According to a fourth aspect, there is provided a signal comprising computer-readable instructions that, when executed by a processor, causes the performance of a method in accordance with the first or second aspects.

According to a fifth aspect, there is provided a computer program that, when read by a computer, causes performance of a method in accordance with the first or second aspects.

According to a sixth aspect, there is provided an apparatus comprising: at least one processor; at least one memory comprising computer-readable instructions; wherein the at least one processor is configured to read the computer readable instructions and cause performance of a method in accordance with the first or second aspects.

The skilled person will appreciate that except where mutually exclusive, a feature described in relation to any one of the above aspects may be applied mutatis mutandis to any other aspect. Furthermore except where mutually exclusive any feature described herein may be applied to any aspect and/or combined with any other feature described herein.

### BRIEF DESCRIPTION OF THE DRAWINGS

The invention will now be described by way of example only, with reference to the Figures, in which:

FIG. 1 is a schematic perspective view of a an applicator head applying fibre reinforcement material on a tool;

FIG. 2 is a schematic cross-sectional view of an applicator roller applying fibre reinforcement material on a substrate received on a tool;

FIG. 3 is a diagrammatic view of an applicator roller in a deformed configuration showing roller crush and head displacement dimensions;

FIG. 4 is a diagrammatic view of an applicator roller showing force balance in an equilibrium condition;

FIG. 5 is a plot showing reaction force profiles at different tow positions as a function of applicator roller deformation;

FIG. 6 is a flowchart of a method of checking headpath data;

FIG. 7 is a flowchart showing a method of determining head displacement of an applicator head;

FIG. 8 is a plot showing tow compaction force, surface and roller profiles for an example substrate surface feature which is generally concave;

FIG. 9 is a plot showing tow compaction force, surface and roller profiles for an example substrate surface feature which is generally convex;

FIG. 10 is a flowchart showing an example method of checking and defining headpath data;

FIG. 11 is a flowchart showing an example method of checking and defining headpath data;

FIG. 12 schematically shows a controller for executing a method of checking and optionally defining headpath data; and

FIG. 13 schematically shows a computer-readable medium comprising instructions and a processor.

### DETAILED DESCRIPTION

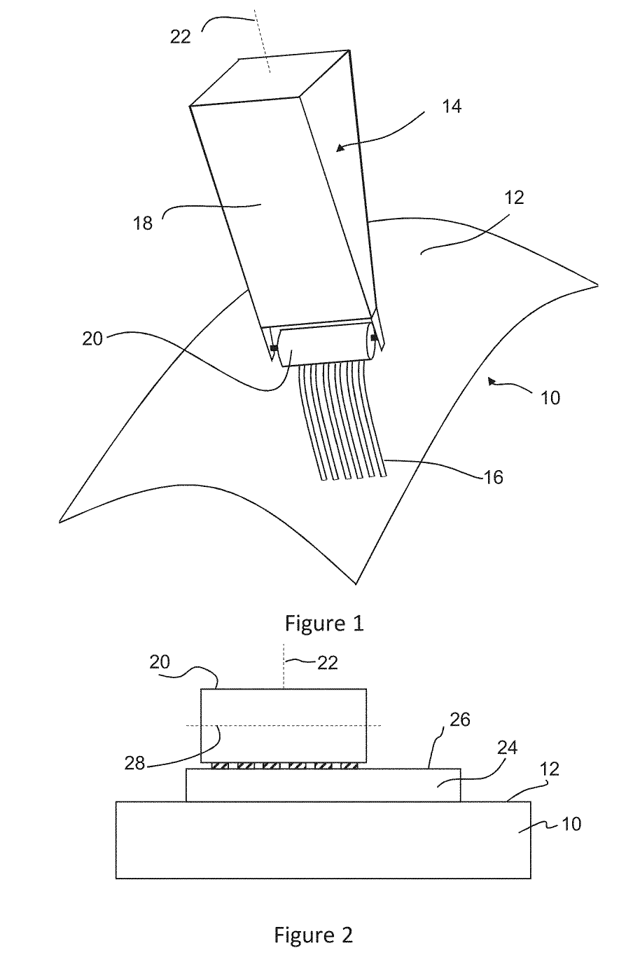

FIG. 1 shows an example tool 10 defining a lay-up surface 12, and an example applicator head 14 disposed over and moveable relative the tool 10 to apply a plurality of tows 16 of fibre reinforcement material onto the lay-up surface 12. The applicator head 14 comprises a head body 18 extending along a generally longitudinal direction and supporting an applicator roller 20 at its distal end configured to traverse the lay-up surface 12 to apply fibre reinforcement material thereto.

As shown in FIG. 1, in this example the head body 18 extends along a generally longitudinal axis from a proximal end farthest from the tool to a distal end where the applicator roller 20 is located for pressing against the tool 10.

The applicator head 14 and tool 10 are moveable relative one another in six degrees of freedom including three degrees of translation and three degrees of rotation. In this particular example, the degrees of freedom are distributed between the tool and the head, such that the tool 10 and applicator head 14 are both configured to move (with respect to different degrees of freedom). For example, the tool 10 may be configured to rotate about two rotational axis of freedom (e.g. pitch and roll) and one translational degree of freedom (e.g. a vertical or “z” direction, whereas the applicator head 14 may be mounted to a support (not shown) and configured to move with respect to the remaining rotational degree of freedom (e.g. “yaw”) and translational degrees of freedom (the lateral or “x” and “y” directions). In other examples, the tool 10 may be configured to remain static whereas the applicator head 10 may be mounted to a support (not shown) configured to manipulate the applicator head 10 with up to six degrees of freedom. In yet further examples, the applicator head 14 may remain static and the tool 10 may be configured to move relative the applicator head 10, but in other examples the degrees of freedom may be distributed between the tool and head in any combination.

The applicator head 14 is mounted to the support by a resilient mount so that it is translatable with respect to the resilient mount along a compaction axis in response to engaging the tool 10 or a substrate received on the tool 10. For example, the resilient mount may comprise a rail configured to support the applicator head and allow relative movement of the applicator along the compaction axis 22 relative the rail. The resilient mount may be coupled to the support so that translational and rotational manipulation is imparted to the applicator head 14 via the resilient mount, separately to the freedom of the applicator head to translate along the compaction axis 22 relative the resilient mount.

The resilient mount defines a travel (i.e. a finite range of linear movement) of the applicator head 14 along the compaction axis 22, and is provided with a biasing mechanism to urge the applicator head 14 along the compaction axis relative the resilient mount towards the tool 10. For example, the travel may be between 5 mm and 20 mm and may depend on the geometry of the tool and component to be formed. In this particular example, the biasing mechanism comprises compressed gas apparatus including a reservoir of compressed gas, a pressure-maintaining valve, and a pneumatic actuator for driving the applicator head 14 along the compaction axis 22. The reservoir of compressed gas is provided so that a compaction pressure or compaction force (for example, approximately 500N to 1000N) acting on the applicator head 14 along the compaction axis 22 remains substantially constant irrespective of the position of the applicator head 14 within its travel.

FIG. 2 shows a partial cross-sectional view of the tool 10 with a substrate 24 received on the lay-up surface 12 of the tool 10. In this example, the substrate 24 is a partially laid pre-form for a composite component, comprising a plurality of successive plies of fibre reinforcement material received on the lay-up surface 12.

As shown schematically in FIG. 2, the applicator roller is positioned over the substrate 24 and tool 10 to press a plurality of tows 16 against a substrate surface 26 of the substrate 24 during a layup operation. The applicator roller 20 has a roller axis 28 about which it is rotatable to move over the substrate surface 26 to apply the tows of fibre reinforcement material thereto. In this example, the roller axis 28 is orthogonal with respect to the compaction axis 22, but in other examples the roller axis 28 may be pivotable to become inclined relative the compaction axis. For example, there may be an amount of play for pivoting the roller axis 28 about a third axis orthogonal to both the compaction axis 22 and the roller axis 28 as shown in FIG. 2.

The applicant has previously utilised methods of laying up fibre reinforcement material in which an applicator head is controlled to position a centre point of an applicator roller against a series of headpath points. The centre point of the applicator roller may be defined as a point on the distal line or surface of the applicator roller in an un-deformed configuration (i.e. the most distal line on the substantially cylindrical roller surface which presses against a tool), and at a central position with respect to the lateral extent of the applicator roller. In some example methods, the applicator head may have a compaction axis as described above which may extend through the distal line or surface of the applicator roller and be centrally aligned so that the centre point can be defined as where the compaction axis intersects the distal line or surface of the applicator roller.

The applicant has found that the headpath points may not correspond directly with a substrate surface to which fibre reinforcement material is to be applied during a layup procedure. For example, the substrate surface may be an exposed surface of a partially-formed pre-form for a composite component, and the headpath point may correspond to the underlying tool surface.

It will be appreciated that where the applicator head is not resiliently moveable along the compaction axis, any inaccuracy in the definition of the headpath point will result in the applicator roller not contacting the substrate surface if the headpath point is set too high (i.e. outside of the true substrate surface), or being driven into the substrate surface (i.e. colliding) if the headpath point is set too low (i.e. within or below the true substrate surface). In the latter case, small tolerances may be accommodated in practice by deformation of a deformable applicator roller, where provided.

In example methods where the applicator head is biased along a compaction axis, discrepancies between the headpath point and the true substrate surface may be accommodated if a travel of the applicator head along the compaction axis is sufficiently high. A bias of the applicator head along a compaction axis may therefore allow for improved reliability in compacting fibre reinforcement material against a substrate surface. Nevertheless, lay-up defects (non-conformance) such as non-compaction of fibre-reinforcement material and collisions between the applicator head and an obstacle may arise.

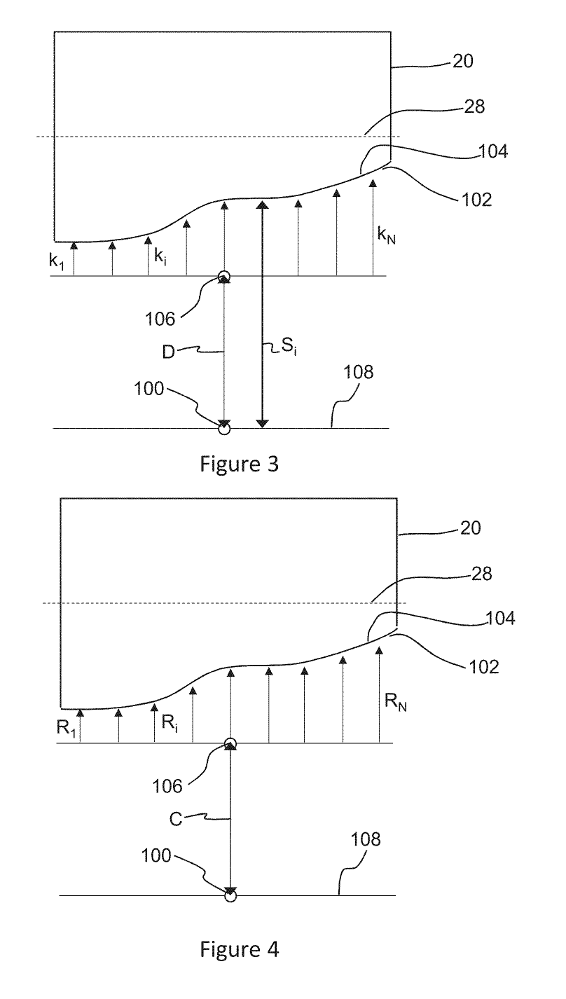

As will now be described with respect to FIGS. 3-9, the applicant has developed methods of checking and of defining headpath data based on determining the displacement (compaction) of the applicator head 14 along the compaction axis 22 relative respective headpath positions.

As will be described in detail below, determining the displacement of the applicator head allows the position of the applicator head to be predicted, which may enable any collision with an obstacle to be predicted. Further, the methods provide for determining a deformed profile of the applicator roller, which may enable non-compaction of fibre-reinforcement material to be predicted. Non-compaction of fibre-reinforcement material may lead to lay-up defects, such as bridging of fibre reinforcement material over depressions (or recesses) in the substrate surface 26, or inadequate application of force or pressure for adhesion and/or frictional resistance to displacement of the fibre reinforcement material during a layup operation.

FIG. 3 and FIG. 4 respectively show diagrams of force balance and displacement of the applicator roller 20 for a respective headpath position.

In this example, a notional or virtual headpath position 100 is defined corresponding to a position on a notional or virtual tool surface. In this example, a substrate is simulated as applied on the virtual tool surface to define a substrate surface 102, which is shown in FIGS. 3 and 4 having a variable profile offset from the virtual headpath position 100.

As will be appreciated, in use the applicator head 14 is positioned to direct the centre point of the applicator roller 20 to the virtual headpath position 100. In this particular example, the applicator head 14 is positioned so that it would be at a mid-position the central position) within the travel of the applicator head 14 when the centre point of the applicator roller is at the virtual headpath position 100 in an un-deformed configuration. Positioning the applicator head 14 in this way may allow for retraction and extension of the applicator head.

As shown in FIG. 3, if the applicator roller 20 is assumed to deform to correspond to the profile of the substrate surface 102, then a deformation profile 104 of the applicator roller 20 along the lateral extent of the applicator roller at its distal line or surface will correspond to the profile of the substrate surface 102. The deformation k along the profile is variable and is shown as discretized for a plurality of tows i, from k₁ to k_{N} where N is the number of tows 16 to be applied. The deformation k is between the deformation profile of the applicator roller and the un-deformed profile of the roller. The centre point 106 (a point on the un-deformed distal line or surface at a central lateral position) is shown to illustrate the un-deformed profile of the applicator roller 20.

The separation between the centre point 106 and the virtual headpath position 100 represents the displacement D of the applicator head 14 along the compaction axis 22.

FIG. 3 also shows a displaced deformation s of the applicator roller 20. The displaced deformation s is equivalent to the cumulative displacement and deformation of the applicator roller 20 as measured from the virtual headpath position 100 (i.e. an un-deformed configuration of the roller 20) to the deformation profile 104 of the applicator roller, along a direction parallel with the compaction axis 28. In particular examples, and as with the deformation k, the displaced deformation s may be discretized in accordance with the number of tows i to be applied along the lateral extent of the roller.

The displaced deformation sᵢ for each tow position may be calculated by determining the separation between the respective portion of the deformation profile 104 of the applicator roller and the binormal vector 108 corresponding to the virtual headpath position 100. For the avoidance of doubt, a binormal vector is a vector orthogonal to both a tangent vector of a curve and a normal vector of the curve. The binormal vector 108 with respect to the virtual headpath position 100 may be determined as orthogonal to a tangent vector of the headpath extending through successive virtual headpath positions 100, and orthogonal to the normal vector of the virtual tool surface at the virtual tool path position. In examples described herein, the applicator head 14 may be positioned so that the compaction axis 22 aligns with the normal vector of the virtual tool surface at the virtual headpath position. However, in other examples the compaction axis 22 may be controllably and variably inclined with respect to the normal vector, for example, in a range of up to 30° (this may be useful to avoid an obstacle).

FIG. 4 shows a force balance diagram for the applicator roller in an equilibrium condition in which a compaction force C applied through the applicator head 14 is equal to the sum of the reaction forces Rᵢ through respective portions (in examples herein, respective tows 16) of fibre reinforcement material when the applicator roller 20 is deformed to correspond to the profile of the substrate surface 102. The force balance can be represented mathematically as shown in Equation 1.

Σᵢ₌₁^{N}Rᵢ=C Equation 1

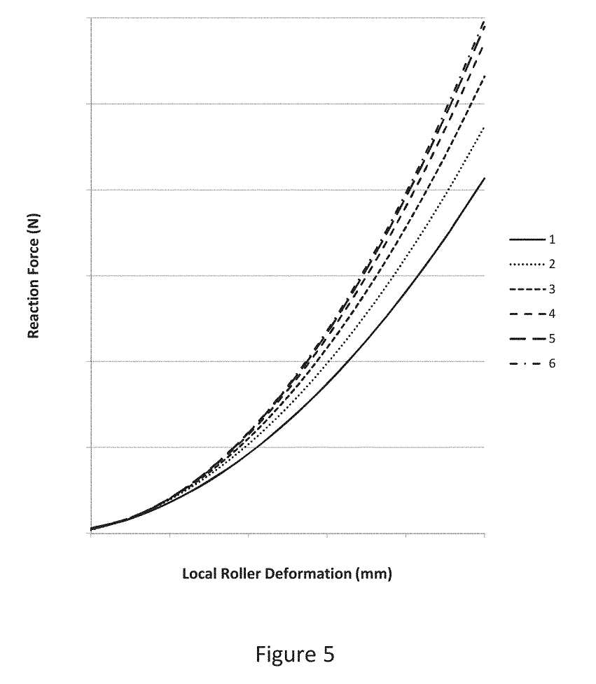

In examples described herein the reaction force Rᵢ is dependent on the local deformation of the applicator roller 20 in a non-linear manner, as shown in FIG. 5. Further, in examples described herein the reaction force Rᵢ is dependent on the lateral position along the applicator roller (again, as shown in FIG. 5). For example, the applicator roller may be more resistant to deformation at a central position along its lateral extent (e.g. owing to support by laterally adjacent portions of the roller), and less resistant to deformation towards its lateral ends. FIG. 5 shows the profile of reaction force with respect to local roller deformation for different tow positions, wherein tow 1 represents a tow position towards a lateral end of the applicator roller, and wherein tow 6 represents tow position laterally adjacent the centre point 106 of the applicator roller.

The profiles of reaction force can be determined empirically by testing as a function of local roller deformation and, optionally, tow position. In other examples the profiles of reaction force may be determined or calculated based on a theoretical model.

In the particular examples described herein, the profiles of reaction force at the respective tow positions are determined empirically to derive a numerical correlation (i.e. one which can be expressed as a algebraic formula), in particular a quadratic equation, for each tow position i, as shown in equation 2.

Rᵢ(i,k)=aᵢkᵢ²+bᵢkᵢ+cᵢ Equation 2

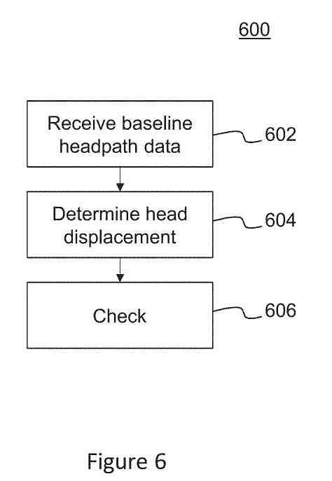

A particular example method of checking headpath data will now be described, by way of example only, with reference to FIGS. 6-8 and based on the descriptions of the apparatus displacements and force balance provided above with respect to FIGS. 1-5.

FIG. 6 shows a flowchart of a method 600 of checking headpath data for layup operation in which fibre reinforcement material is applied over a tool 10 by an applicator roller 14 biased against the tool along a compaction axis 22 by a compaction force C, as described above with respect to FIGS. 1-4.

In block 602, baseline headpath data is received, for example from a headpath datafile stored in a memory of a computer. In this example, the baseline headpath data defines baseline headpath positions for positioning the applicator head 14 relative the tool.

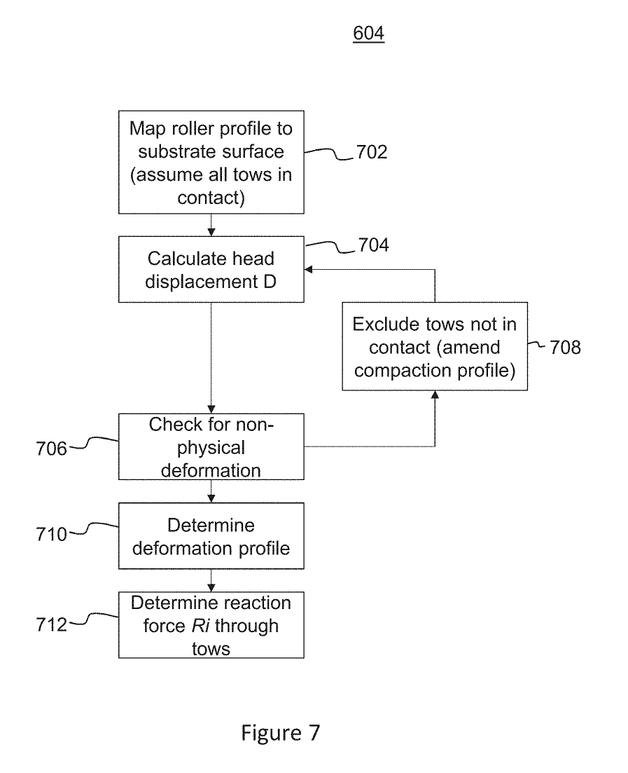

In block 604, the headpath displacement 1) of the applicator head 14 at the baseline headpath position is determined based on evaluating an equilibrium condition between the compaction force C and a reaction force through the fibre reinforcement material 16, as will be described in detail below with respect to FIG. 7.

In block 606, a check is conducted for at least one of a non-compacted portion of fibre reinforcement material 16 along a lateral extent of the applicator roller; and an intersection of the applicator head 14 and an obstacle, based on the head displacement.

In this particular example, both checks are conducted. The check for a non-compacted portion of fibre reinforcement material 16 is conducted based on the deformation profile of the applicator roller at the equilibrium condition, as will be described in detail below with respect to FIG. 7.

The check for an intersection of the applicator head 14 and an obstacle is conducted by simulating the geometry of the applicator head 14 relative an obstacle or set of obstacles. In this example, the set of obstacle includes the tool 10, a substrate 24 received on the tool 10 (e.g. a partially-formed pre-form for a composite component as applied onto the tool 10), support equipment for the applicator head 14 and the tool 10, and any ancillary equipment for example vacuum bagging equipment (not shown). By first determining the head displacement D, the position of the applicator head 14 relative the tool 10 (and other obstacles, accordingly) can be accurately predicted.

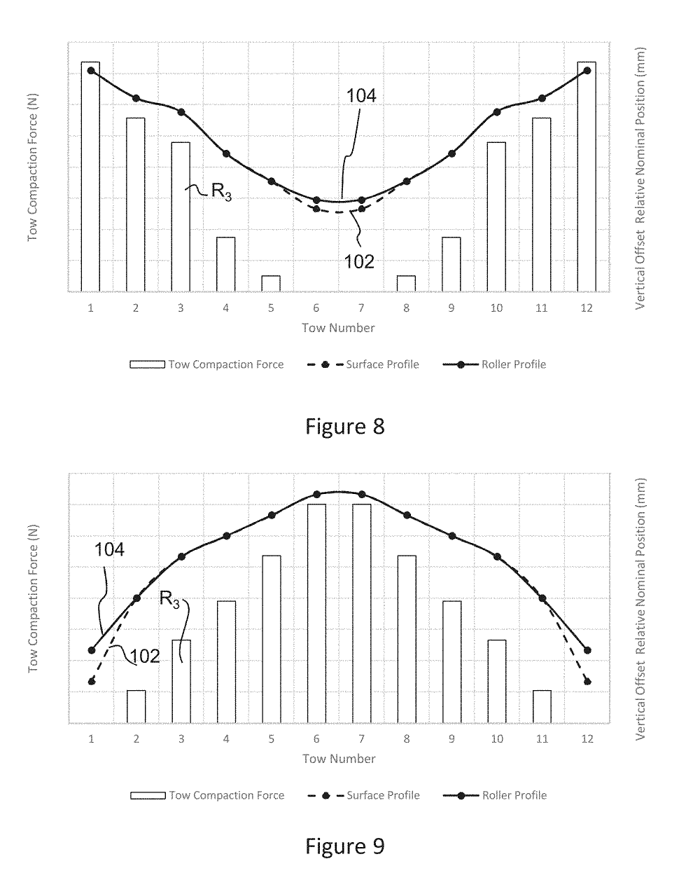

FIG. 7 shows a flowchart of a sub-method 604 of determining the head displacement D (corresponding to block 604 of FIG. 6). The sub-method will be described by reference to an example substrate surface profile 102 as shown in FIG. 8.

FIG. 8 shows a combination plot depicting a profile of a substrate surface 102 (data series “Surface Profile”). In the examples described herein, the substrate surface 102 is a surface that is simulated, for example by a processor of a computer conducting the method 600. The substrate surface 102 may correspond to a lay-up surface of the tool 10 when the respective headpath position corresponds to a headpath to be laid directly onto the tool 10, or may correspond to an exposed (or upper) surface of a substrate 24 simulated as applied on the tool. For example, for a headpath position corresponding to an intermediate-depth ply of a pre-form for a composite component, the substrate 24 may be simulated as applied on the tool up to the respective headpath position.

As shown in FIG. 8, in this example the surface profile 102 is substantially identical to a deformation profile 104 (data series “Roller Profile”) of the applicator roller 20 for all but a central portion of the surface profile corresponding to tow positions 6 and 7.

Referring back to FIG. 7, in block 702 of the sub-method 604, the profile of the roller (i.e. the deformation profile 104) is mapped to the profile of the substrate surface to reflect an assumption that the roller 20 can deform to compact all tows 16 to be applied along the lateral extent of the roller. Accordingly, in block 702, the deformation profile 104 of the roller is set to match the surface profile 102 of the substrate surface. This initial condition is contrary to what is shown in FIG. 7 with respect to the central tow positions (positions 6 and 7), for reasons that will become clear in the following description.

In block 704, the head displacement D is determined based on evaluating an equilibrium condition of the roller 20 when the reaction force through fibre reinforcement material compacted by the roller 20 is equal to the compaction force C which biases the applicator head 14 (including the roller 20) against the tool 10. In this particular example, the reaction force Rᵢ through respective tows 16 at tow positions i can be determined based on the relationships as previously described with respect to Equations 1 and 2 and FIG. 5, and will now be described with reference to the diagrammatic illustrations of force balance, displacement and deformation of FIGS. 3 and 4.

Since the roller deformation kᵢ for each tow position i is equal to the displaced deformation sᵢ for the respective tow less the head displacement D (i.e. kᵢ=sᵢ−D), an equilibrium equation balancing the sum of the reaction forces Rᵢ and the head compaction force C can be re-arranged as shown below in Equation set 3.

Σᵢ₌₁^{N}aᵢkᵢ²+bᵢkᵢ+cᵢ=C

Σᵢ₌₁^{N}aᵢ(sᵢ−D)²+bᵢ(sᵢ−D)+cᵢ=C

Σᵢ₌₁^{N}aᵢsᵢ²=2aᵢsᵢD+aᵢD²+bᵢsᵢ−bᵢD+cᵢ=C

Σᵢ₌₁^{N}aᵢD²+(−2aᵢsᵢ−bᵢ)D+(aᵢsᵢ²+bᵢsᵢ+cᵢ)=C

D²Σᵢ₌₁^{N}aᵢ+DΣᵢ₌₁^{N}(−2aᵢsᵢ−bᵢ)+Σᵢ₌₁^{N}(aᵢsᵢ²+bᵢsᵢ+cᵢ)−C=0 Equation Set 3

The final equation in equation set 3 is a quadratic equation that is a function of D, and therefore D can be solved for using the quadratic formula as shown in Equation 4 (noting that, in this particular example a positive solution is physical and a negative solution would be non-physical).

$$D = \frac{\begin{matrix}{\sum }_{i = 1}^{N} ( 2 {a}_{i} {s}_{i} + {b}_{i} ) - \\ \sqrt{{( {\sum }_{i = 1}^{N} ( 2 {a}_{i} {s}_{i} + {b}_{i} ) )}^{2} - 4 {\sum }_{i = 1}^{N} {a}_{i} ( {\sum }_{i = 1}^{N} ( {a}_{i} {s}_{i}^{2} + {b}_{i} {s}_{i} + {c}_{i} ) - C )}\end{matrix}}{( 2 {\sum }_{i = 1}^{N} {a}_{i} )} \qquad Equation 4$$

Based on the head displacement D and the displaced deformation sᵢ at each tow position, the respective deformations kᵢ at the tow positions can be determined based on Equation 5.

kᵢ=sᵢ−D Equation 5.

In block 706, it is determined whether the deformation kᵢ for each tow position is negative, such that the deformation at the respective tow position would be determined as non-physical. When the deformation kᵢ is negative, an extension of the roller 20 is implied from its un-deformed configuration, rather than a depression (or crush) of the roller 20.

If it is determined that the deformation kᵢ for any of the tow positions is negative, then in block 708 a compaction profile of the applicator roller, initially assumed to represent compaction of fibre reinforcement material along the full lateral extent of the roller (as described above), is adjusted to exclude tows determined to be non-compacted for reason of non-physical deformation.

The head displacement D is then recalculated in block 704 as described above, based on the adjusted compaction profile.

In this particular example, and as shown in FIG. 8, the initial calculation of the head displacement D results in non-physical compaction of the roller 20 at tow positions 6 and 7, as determined in block 706, such that the compaction profile is adjusted at these tow positions in block 708 and the head displacement D is recalculated at block 704.

In this example, after a second calculation of the head displacement D the deformation profile 104 of the roller 20 is found to be physical (rather than non-physical or degenerate) at all tow positions i in block 706. In block 710, the deformation profile 104 of the applicator roller 20 is stored as correlated to the respective headpath position, for example in a memory of a computer, for later retrieval.

In block 712, the reaction force Rᵢ imparted on the applicator roller 20 through the each of the respective tows 16 at the tow positions i is determined based on Equation 6.

Rᵢ(i,k)=aᵢkᵢ²+bᵢkᵢ+cᵢ Equation 6

The reaction force Rᵢ for the example described above with respect to FIG. 8 is shown in FIG. 8 for the respective tow positions. It can be seen that the reaction force is at a peak for those lateral portions of the applicator roller which are most severely deformed (crushed) to conform to the substrate surface profile 102, in particular, at the lateral end regions of the applicator roller. The reaction force reduces as the deformation k reduces, and is zero where the deformation profile 104 of the roller 20 departs from the substrate surface profile 102 such that there is non-compaction of a corresponding portion of fibre-reinforcement material (i.e. at tow positions 6 and 7).

Referring back to FIG. 6, the check in block 606 for non-compaction of fibre-reinforcement material is conducted in this example based on comparing the deformation profile 104 of the roller 20 with the substrate surface profile 102, such that non-compaction is determined to be present where the deformation profile 104 as stored in memory differs from the substrate surface profile. In other examples, non-compaction of fibre reinforcement material may be determined based on the compaction profile, which is determined in block 706 of the sub-method 604 of determining the head displacement D based on the deformation profile 104 of the applicator roller.

Although the above example of checking headpath data is described with respect to a single baseline headpath position, it will be appreciated that in other examples headpath data defining a series of baseline headpath positions can be checked.

FIG. 9 shows a further example of deformation of the applicator roller 20 to conform to a substrate surface profile 102 at a second baseline headpath point. In this example, the substrate surface profile 102 is generally convex. During calculation of the head displacement D, it is determined that there is non-physical deformation at tow positions 1 and 12 at the lateral ends of the applicator roller 20, such that these tow positions are excluded from the reaction force calculations and the compaction profile is adjusted accordingly, as described above.

In the above described examples, methods of checking headpath data enable feedback to be generated (for example, within a headpath validation or design procedure) as to non-compaction or collision. Example methods will now be described in which headpath data is defined based on the above-described methods of checking headpath data.

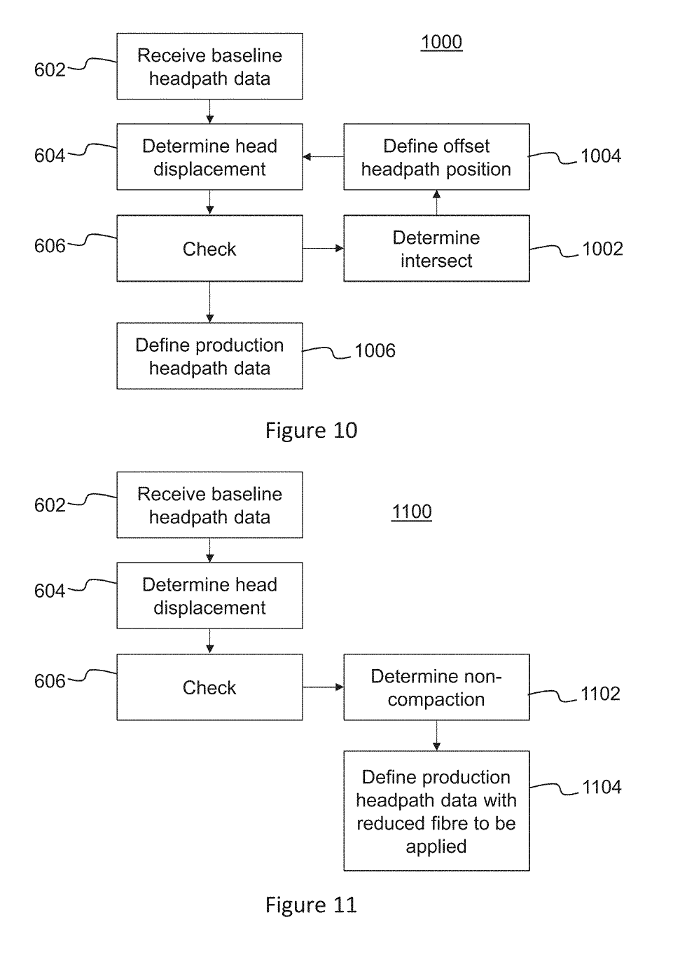

FIG. 10 shows an example method 1000 of checking and defining headpath data in which baseline headpath data defining a baseline headpath position 100 is received (block 602), head displacement is determined (block 604), and checks performed (block 606) in accordance with the method 600 described above with respect to FIGS. 6 and 7.

In this example, an intersection is determined in block 1002 based on a check for intersections (otherwise known as collisions) in block 606. For example, the intersection may be between a portion of the applicator head and a part of the tool 10. Such intersections may be particularly prone to occur for highly curved tool and substrate geometries, or for small parts.

In block 1004 an offset headpath position is defined based on the baseline headpath position. The head displacement D is then re-determined in block 604 and the checks repeated for the offset headpath position in block 606. This loop may be repeated until the or each check is clear (i.e. no intersection/collision is detected, and/or no non-compacted portion of fibre reinforcement material). In block 1006, production headpath data (i.e. headpath data for a lay-up procedure) is defined based on the offset headpath position.

The offset headpath position may be defined to avoid an intersection which is detected. For example, an intersection may be detected between the applicator head 14 and an obstacle, and the offset headpath position may be defined to translate the applicator head 14 relative the obstacle to avoid the obstacle.

The offset headpath position may be defined as part of defining an offset headpath. For example, a portion of a baseline headpath comprising a plurality of baseline headpath positions for which one or more non-conformance checks return a positive result (e.g. a collision or non-compaction of fibre-reinforcement material) may be re-plotted by offsetting the baseline headpath to define an offset headpath. The offset headpath, or the individual offset headpath position may be defined automatically based on an offsetting procedure of the computer program, or may be semi-automatically defined by highlighting the location of non-conformance (e.g. a collision or non-compaction of fibre-reinforcement material), and providing a prompt for user input to offset the baseline headpath or the baseline headpath position (for example, by clicking and dragging a baseline headpath position over a virtual tool surface 100).

FIG. 11 shows a further example method 1100 of checking and defining headpath data.

As previously described with respect to FIG. 10, the method comprises receiving baseline headpath data defining a baseline headpath position (block 602), determining head displacement D (block 604) and conducting non-conformance or validation checks (block 606).

In this example method, in block 1102 a portion of non-compacted fibre reinforcement material is determined. In this example, non-compaction is determined based on the compaction profile of the applicator roller 20 which is iteratively adjusted during the determination of the deformation profile of the applicator roller 20 and the head displacement D as described above.

In this example, the portion of non-compacted fibre reinforcement material is determined by identifying tow positions where non-compaction occurs. Considering the substrate surface of FIG. 9 as an example, non-compaction would be determined in block 1102 for tow positions 1 and 12.

In other examples, non-compaction may be determined over a portion of fibre reinforcement material provided as a tape (as in Automatic Tape Laying (ATL) processes), or as a bundle of fibres (as in Automatic Filament Winding), and the lateral extent of fibre reinforcement material to be applied by the applicator roller may be discretized accordingly, for example in portions of a predetermined width.

In block 1104, production headpath data is defined based on the baseline headpath data so that the lateral extent of fibre reinforcement material to be applied is reduced, relative a default or standard lateral extent.

The default or standard lateral extent may be a maximum lateral extent of fibre-reinforcement material that can be applied by the applicator roller or which is selected as a maximum for application in the definition of the baseline headpath data. The standard lateral extent may correspond to a maximum lateral extent as determined along the production headpath, such that the lateral extent varies along the headpath.

In this particular example, baseline headpath data is received which specifies that 12 tows are to be applied along the headpath. In this example, in block 1104 the production headpath data is defined to exclude tows in tow positions 1 and 12 from being applied during the lay-up procedure, so as to avoid non-compaction of fibre reinforcement material.

It will be appreciated that the production headpath data may be defined so that each tow has a minimum elongate extent as applied, and therefore any instructions to defined the production headpath data may include procedures for determining the lateral extent to be applied at a particular headpath position based on the lateral extent to be applied at other headpath positions.

In some examples, where non-compaction is determined, the lateral extent will be reduced accordingly over a headpath portion corresponding to a plurality of successive headpath positions, even if non-compaction is only determined at a subset, which may be one, of the headpath positions. This may avoid discontinuities in the lateral extent of fibre-reinforcement material to be applied. This may be particularly appropriate where non-compaction is determined towards a lateral end of the applicator roller.

In other examples, a new offset headpath position (or offset headpath) may be defined when non-compaction is determined so that the centre point of the applicator roller 20 is moved relative a feature of the substrate surface corresponding to the non-compaction of fibre-reinforcement material. In some examples, the applicator roller may be offset so that, at the offset headpath position the applicator roller does not engage the respective feature of the substrate surface. In other examples, the applicator roller may be offset in the offset headpath position so that the respective feature of the substrate surface moves relatively away from the centre point of the applicator roller and towards a lateral end of the applicator roller. To take an example, considering the generally concave substrate surface 102 described with reference to FIG. 8, non-compaction at central tow positions (tow positions 6 and 7) may result in offsetting the baseline headpath position laterally to define an offset headpath position which results in the respective substrate surface feature underlying tow path positions 1 and 2, or 11 and 12, corresponding to a lateral end of the applicator roller. In some examples, this may allow the applicator roller to compact the respective portion, for example because the applicator roller may be more readily deformable at its lateral ends, or because the orientation of the applicator head 14 can be inclined based on the normal vector of the respective portion of the substrate surface so that the distal line or surface of the applicator roller better corresponds to the profile of the substrate surface.

Correspondingly, other portions of a headpath, such as laterally adjacent positions, may be offset.

The term “production headpath data” is used herein to refer to headpath data that may be used in a manufacturing process, i.e. after validation processes. For the avoidance of doubt, the above descriptions of the definition of production headpath data based on baseline headpath data do not exclude such processes having further intermediate steps, for example, further checks and optimisations to be performed on the headpath positions and the lateral extent of fibre reinforcement material to be applied.

Although specific examples have been described herein with respect to applying fibre reinforcement in the form of a plurality of laterally adjacent tows (Automatic Fibre Placement, AFP), it will be appreciated that other examples methods may be based on applying fibre reinforcement tapes (Automatic Tape Laying, ATL), or a bundle of fibres (automatic filament winding).

It will be appreciated that the methods described herein with respect to FIGS. 3-11 may be implemented in a computer, such as a general purpose computer, or in an apparatus comprising a controller configured to implement the methods.

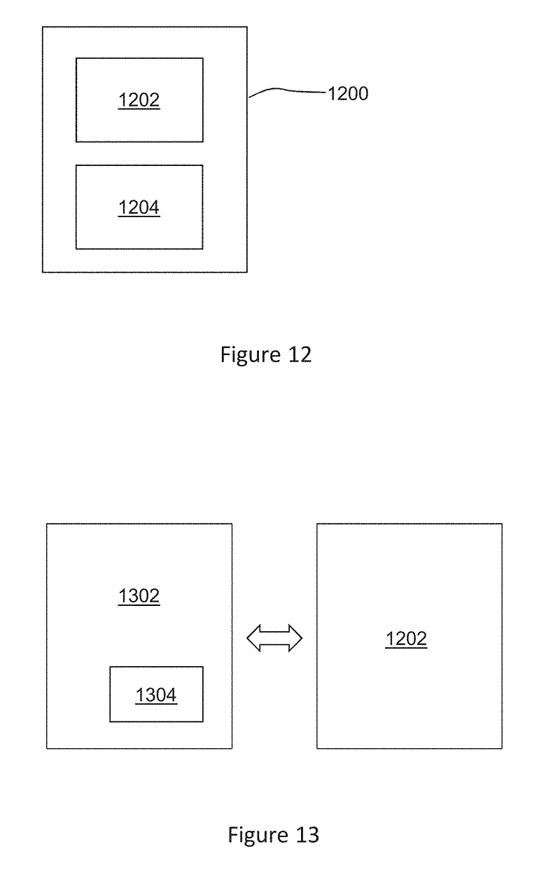

An example controller 1200 is shown, by way of an example, in FIG. 12. In this example, the controller comprises at least one processor 1202 and at least one memory 1204. The memory 1204 stores a computer program comprising computer readable instructions that, when read by the processor, causes performance of at least one of the methods described herein with respect to FIGS. 6-7 and 10-11. The computer program may be software or firmware, or may be a combination of software and firmware.

The processor 1202 may include at least one microprocessor and may comprise a single core processor, may comprise multiple processor cores (such as a dual core processor or a quad core processor), or may comprise a plurality of processors (at least one of which may comprise multiple processor cores).

The memory 1204 may be any suitable non-transitory computer readable storage medium, data storage device or devices, and may comprise a hard disk and/or solid state memory (such as flash memory). The memory 1204 may be permanent non-removable memory, or may be removable memory (such as a universal serial bus (USB) flash drive).

As shown in FIG. 13, a computer program 1304 may be stored on a non-transitory computer readable storage medium 1302. The computer program may be executable by a processor 1202 to cause performance of at least one of the methods described herein with respect to FIGS. 6-7 and 10-11. The computer program 1304 may be transferred from the non-transitory computer readable storage medium 1302 to the memory 1204 of FIG. 12. The non-transitory computer readable storage medium 1302 may be, for example, a USB flash drive, a compact disc (CD), a digital versatile disc (DVD) or a Blu-ray disc. In some examples, the computer program may be transferred to the memory via a wireless signal or via a wired signal.

Further, the computer program comprising computer readable-instructions may be transmitted by a signal that, when executed by a processor, causes the performance of at least one of the methods described herein with respect to FIGS. 6-7 and 10-11.

It will be understood that the invention is not limited to the examples above-described and various modifications and improvements can be made without departing from the concepts described herein. Except where mutually exclusive, any of the features may be employed separately or in combination with any other features and the disclosure extends to and includes all combinations and sub-combinations of one or more features described herein.

What is claimed is:

1. A computer-implemented method of checking headpath data for a layup operation in which fibre reinforcement material is applied over a tool by an applicator roller of an applicator head biased against the tool along a compaction axis by a compaction force, the method comprising:
receiving baseline headpath data defining a baseline headpath position of the applicator head relative the tool for applying fibre reinforcement material onto a substrate surface by the applicator roller;
determining a head displacement along the compaction axis corresponding to an equilibrium condition between the compaction force and a reaction force through the fibre reinforcement material applied by the applicator roller; and
checking for at least one of:
a non-compacted portion of fibre reinforcement material along a lateral extent of the applicator roller based on a deformation profile of the applicator roller at the equilibrium condition; and
an intersection of the applicator head and an obstacle, based on the head displacement distance.

2. A method according to claim 1 further comprising:
determining an intersection of the applicator head in the baseline headpath position and an obstacle;
defining an offset headpath position offset from the baseline headpath position to avoid the intersection; and
defining production headpath data for a layup operation including the offset headpath position.

3. A method according to claim 2, further comprising repeating checking for a non-compacted portion of fibre reinforcement material or an intersection of the applicator head and an obstacle at the offset headpath position.

4. A method according to claim 3, wherein the production headpath data is defined for a layup operation in which a plurality of laterally-adjacent tows are applied by the applicator roller, wherein at least one tow is determined to be non-compacted based on the deformation profile of the applicator roller at the equilibrium condition; and wherein the production headpath data is defined to exclude at least one tow at the baseline headpath position.

5. A method according to claim 1, further comprising
determining a non-compacted portion of fibre reinforcement material based on the deformation profile of the applicator roller at the equilibrium condition;
defining an offset headpath position offset from the baseline headpath position based on the location of the non-compacted portion to laterally offset a centre of the applicator roller from a position on the substrate surface corresponding to the non-compacted portion; and
defining production headpath data for a layup operation including the offset headpath position.

6. A method according to claim 5, further comprising repeating checking for a non-compacted portion of fibre reinforcement material or an intersection of the applicator head and the obstacle at the offset headpath position.

7. A method according to claim 6, wherein the production headpath data is defined for a layup operation in which a plurality of laterally-adjacent tows are applied by the applicator roller, wherein at least one tow is determined to be non-compacted based on the deformation profile of the applicator roller at the equilibrium condition; and wherein the production headpath data is defined to exclude at least one tow at the baseline headpath position.

8. A method according to claim 1, further comprising:
determining a non-compacted portion of fibre reinforcement material based on the deformation profile of the applicator roller at the equilibrium condition; and
defining production headpath data for a layup operation including the baseline headpath position, wherein the production headpath data defines a reduced lateral extent of fibre reinforcement to be applied at the baseline headpath position to exclude the non-compacted portion.

9. A method according to claim 8, wherein the production headpath data is defined for a layup operation in which a plurality of laterally-adjacent tows are applied by the applicator roller, wherein at least one tow is determined to be non-compacted based on the deformation profile of the applicator roller at the equilibrium condition; and wherein the production headpath data is defined to exclude at least one tow at the baseline headpath position.

10. A method according to claim 1, wherein a non-compacted portion is determined when a corresponding portion of the deformation profile of the applicator roller is non-physical, or when a reaction force through the corresponding portion of the deformation profile is below a predetermined threshold.

11. A method according to claim 1, wherein the deformation profile at the equilibrium condition is determined by mapping the lateral profile of the applicator roller to the substrate surface.

12. A method according to claim 11, wherein the equilibrium condition is resolved to determine the head displacement by determining the reaction force through the fibre reinforcement material as a function of the deformation profile.

13. A method according to claim 12, wherein the reaction force through the fibre reinforcement material is determined based on an iteratively-adjusted compaction profile defining regions of compaction of the fibre reinforcement material by the applicator roller along the lateral extent of the applicator roller, and wherein the compaction profile is iteratively adjusted to exclude regions of non-physical deformation of the applicator roller to compact the fibre reinforcement material.

14. A method according to claim 12, wherein the reaction force through the fibre reinforcement material is determined based on a correlation between deformation of the applicator roller and the reaction force which varies laterally along the applicator roller.

15. A method of defining headpath data including a plurality of headpath positions defining a headpath of relative movement of an applicator head relative a tool to apply fibre reinforcement material onto a substrate surface by an applicator roller of the applicator head, the applicator head being biased against the tool along a compaction axis by a compaction force;
wherein the headpath data for at least one of the headpath positions is checked and defined by:
receiving baseline headpath data defining a baseline headpath position of the applicator head relative the tool for applying fibre reinforcement material onto a substrate surface by the applicator roller;
determining a head displacement along the compaction axis corresponding to an equilibrium condition between the compaction force and a reaction force through the fibre reinforcement material applied by the applicator roller; and
checking for at least one of:
a non-compacted portion of fibre reinforcement material along a lateral extent of the applicator roller based on a deformation profile of the applicator roller at the equilibrium condition; and
an intersection of the applicator head and an obstacle, based on the head displacement distance;
determining a non-compacted portion of fibre reinforcement material based on the deformation profile of the applicator roller at the equilibrium condition; and
defining production headpath data for a layup operation including the baseline headpath position, wherein the production headpath data defines a reduced lateral extent of fibre reinforcement to be applied at the baseline headpath position to exclude the non-compacted portion
so that a lateral extent of fibre-reinforcement material to be applied varies along the headpath.

16. A non-transitory computer-readable storage medium comprising computer-readable instructions that, when executed by a processor, causes performance of a method in accordance with claim 1.

17. A computer program that, when read by a computer, causes performance of a method in accordance with claim 1.
